(19) United States
(12) Patent Application Publication
(10) Pub. No.: US 2011/0075941 A1
(43) Pub. Date: Mar. 31, 2011

(54) DATA MANAGING APPARATUS, DATA MANAGING METHOD AND INFORMATION STORING MEDIUM STORING A DATA MANAGING PROGRAM

(75) Inventor: Hirokazu BANNO, Iwakura-shi (JP)

(73) Assignee: BROTHER KOGYO KABUSHIKI KAISHA, Nagoya-shi (JP)

(21) Appl. No.: 12/890,247

(22) Filed: Sep. 24, 2010

(30) Foreign Application Priority Data
Sep. 30, 2009 (JP) 2009-227763

(51) Int. Cl. G06K 9/72; G06F 17/21

(52) U.S. Cl. 382/229; 704/10

(57) ABSTRACT

A data managing apparatus having a word extracting portion that extracts one or a plurality of words from document data and a correlating portion that correlates the words extracted by the word extracting portion with related data related to the document data, includes a frequency storage portion having information about a frequency of each of the words stored thereon for each word; an infrequently-appearing word selecting portion that selects an infrequently-appearing word having the frequency lower than a given threshold value predetermined among the words extracted by the word extracting portion based on the information stored in the frequency storage portion; and a frequency updating portion that updates the information about frequency stored in the frequency storage portion in accordance with extraction by the word extracting portion or correlation by the correlating portion, the correlating portion correlating the infrequently-appearing word selected by the infrequently-appearing word selecting portion among the words extracted from the document data by the word extracting portion with the related data related to the document data.

### BACKGROUND OF THE INVENTION

1. Field of the Invention

The present invention relates generally to a data managing apparatus, an attached data managing method, and an information storing medium storing an attached data managing program that manages related data related to document data, and, more particularly, to a technique for managing related data by correlating a proper word to the related data.

2. Description of the Related Art

A data managing apparatus is known that includes a word extracting portion that extracts one or a plurality of words from document data and a correlating portion that correlates the words extracted by the word extracting portion with related data related to the document data. The described digital image accumulating apparatus (data managing apparatus) automatically correlates and stores a word included in a body text (document data) of e-mail and image data (related data) attached to the e-mail, for example, when the e-mail is received. The word correlated with the image data is used as a marker, for example, when desired data is retrieved from a plurality of image data or when a plurality of image data is classified. Such a data managing apparatus facilitates management of related data since it is not necessary to artificially set a word correlated with the related data for each related data.

Although the conventional data managing apparatus correlates all the words included in document data with related data, those words include a word appearing at not less than a certain frequency when the correlation is performed. Therefore, it is problematic that a word correlated with related data may not suitable for representing related data and may have less value as a marker.

### SUMMARY OF THE INVENTION

The present invention was conceived in view of the situations and it is therefore the object of the present invention to provide a data managing apparatus, a data managing method, and a data managing program capable of automatically correlating a proper word with related data.

A first aspect of the invention according for achieving the object provides a data managing apparatus having (a) a word extracting portion that extracts one or a plurality of words from document data and a correlating portion that correlates the words extracted by the word extracting portion with related data related to the document data, comprising (b) a frequency storage portion having information about a frequency of each of the words stored thereon for each word; (c) an infrequently-appearing word selecting portion that selects an infrequently-appearing word having the frequency lower than a given threshold value predetermined among the words extracted by the word extracting portion based on the information stored in the frequency storage portion; and (d) a frequency updating portion that updates the information about frequency stored in the frequency storage portion in accordance with extraction by the word extracting portion or correlation by the correlating portion, (e) the correlating portion correlating the infrequently-appearing word selected by the infrequently-appearing word selecting portion among the words extracted from the document data by the word extracting portion with the related data related to the document data.

A second aspect of the invention provides a data managing method having (a) a word extracting step of extracting one or a plurality of words from document data and a correlating step of correlating the words extracted at the word extracting step with related data related to the document data, comprising (b) a frequency storage step of storing information about a frequency of each of the words for each word; (c) an infrequently-appearing word selecting step of selecting an infrequently-appearing word having the frequency of the word lower than a given threshold value predetermined among the words extracted at the word extracting step based on the information stored at the frequency storage step; and (d) a frequency updating step of updating the information about frequency stored at the frequency storage step in accordance with extraction at the word extracting step or correlation at the correlating step, wherein (e) at the correlating step, the infrequently-appearing word selected at the infrequently-appearing word selecting step among the words extracted from the document data at the word extracting step is correlated with the related data related to the document data.

A third aspect of the invention provides an information storing medium storing a data managing program for (a) driving a computer to act as a word extracting portion that extracts one or a plurality of words from document data and a correlating portion that correlates the words extracted by the word extracting portion with related data related to the document data, the data managing program further driving the computer to act as (b) a frequency storage portion having information about a frequency of each of the words stored thereon for each word; (c) an infrequently-appearing word selecting portion that selects an infrequently-appearing word having the frequency of the word lower than a given threshold value predetermined among the words extracted by the word extracting portion based on the information stored in the frequency storage portion; and (d) a frequency updating portion that updates the information about frequency stored in the frequency storage portion in accordance with extraction by the word extracting portion or correlation by the correlating portion, (e) the correlating portion correlating the infrequently-appearing word selected by the infrequently-appearing word selecting portion among the words extracted from the document data by the word extracting portion with the related data related to the document data.

### BRIEF DESCRIPTION OF THE DRAWINGS

FIG. 1 is a diagram for explaining a configuration of a computer of one embodiment of the present invention;

FIG. 2 is a functional block diagram for explaining a relevant portion of a control function of an electronic control device of a computer depicted in FIG. 1;

FIG. 3 is a diagram of an example of information about the number of times of correlation stored in a frequency storage portion of FIG. 2;

FIG. 4 is a diagram exemplarily illustrating a portion of information stored in an image data information storage portion of FIG. 2, i.e., a portion of information about image data and words correlated therewith;

FIG. 5 is a diagram of an example of a viewing screen of e-mail displayed on a displaying device of FIG. 1;

FIG. 6 is a diagram of an example of a display screen displayed on the displaying device of FIG. 1 at the activation of image search software for searching image data correlated with a word identical or similar to a desired search keyword among image data stored in a storage device of FIG. 1;

FIG. 7 is a flowchart for explaining the control operation of the electronic control device of FIG. 1 for correlating a proper word with image data stored in the storage device of FIG. 1;

FIG. 8 is a flowchart for explaining the control operation for searching image data correlated with a word identical or similar to a given search word among image data stored in the storage device of FIG. 1;

FIG. 9 is a diagram of an example of information about the number of times of extraction stored in the frequency storage portion of FIG. 2 in another embodiment of the present invention, corresponding to FIG. 3 of the first embodiment;

FIG. 10 is a diagram of a display screen displayed on the displaying device of FIG. 1 when a predetermined operation is performed to activate image search software for correlating proper words with image data stored in the storage device of FIG. 1 and searching image data correlated with a word identical or similar to a desired search keyword among the image data;

FIG. 11 is a flowchart for explaining the control operation of the electronic control device of FIG. 1 for extracting words from document data made related to image data stored in the storage device of FIG. 1 and storing information about the number of times of extraction for each of the word; and

FIG. 12 is a flowchart for explaining the control operation of the electronic control device of FIG. 1 for correlating proper words with image data stored in the storage device of FIG. 1 and searching image data correlated with a word identical or similar to a given search keyword among the image data.

### DESCRIPTION OF THE PREFERRED EMBODIMENTS

Exemplary embodiments of the present invention will now be described in detail with reference to the drawings. The figures are simplified or modified as needed in the following embodiments and do not necessarily depict portions with correct dimensional ratios, shapes, etc.

### First Embodiment

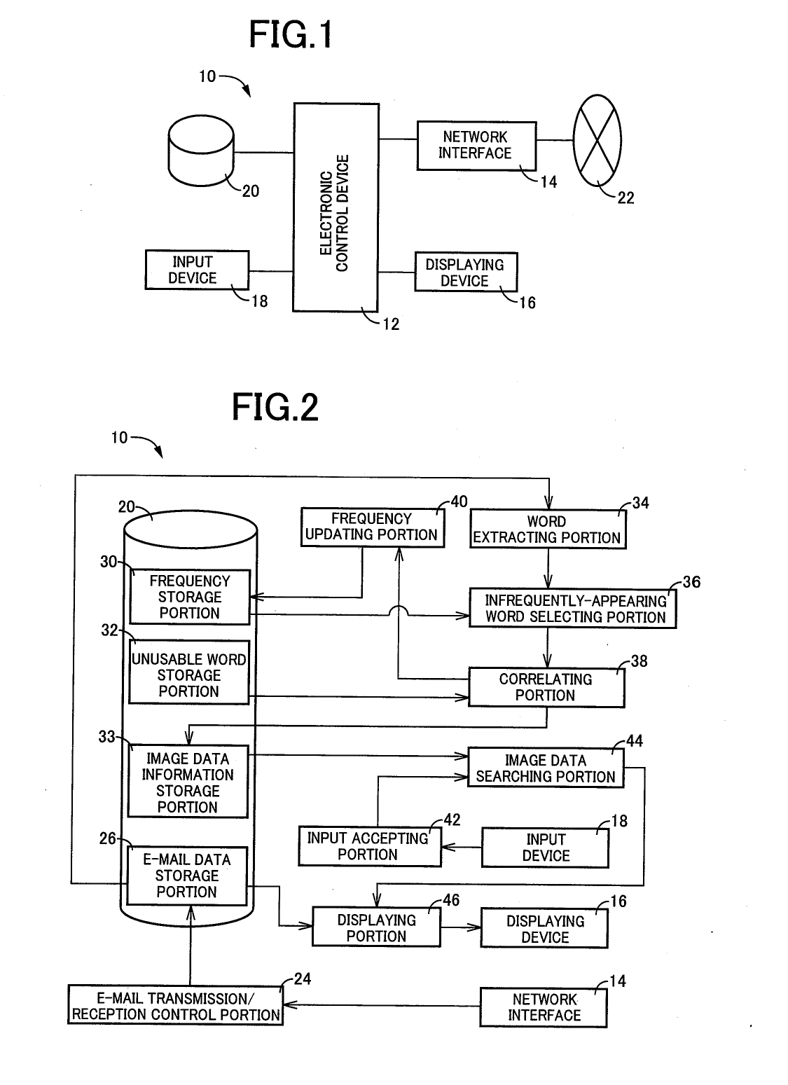

In FIG. 1, a computer 10 is driven by a data managing program stored in an electronic control device 12 or a storage device 20 described later to act as a data managing apparatus and corresponds to a data managing apparatus of the present invention. The computer 10 includes the electronic control device 12, a network interface 14, a displaying device 16, an input device 18, and the storage device 20.

The electronic control device 12 includes a so-called microcomputer equipped with CPU, RAM, ROM, and I/O interface, for example, and the CPU executes a signal process in accordance with various programs stored in the ROM or the storage device 20 in advance while utilizing a temporary storage function of the RAM to execute various functions. For example, the CPU executes signal processes in accordance with an information transmission/reception program to implement an information transmission/reception function executed through the network interface 14 and the input device 18 with another device or storage medium. For example, the CPU executes a signal process in accordance with a document creation program to implement a document creation function for creating a document in accordance with character input through, for example, a keyboard included in the input device 18. For example, the CPU executes a signal process in accordance with a data managing program to correlate a proper word to related data, for example, image data related to a document data stored in the storage device 20 to implement a data managing function for managing the related data.

The network interface 14 connects the computer 10 to a communication line 22, for example, a public telephone line to enable transmission/reception of information to/from another electronic device, for example, a computer connected to the communication line 22. The information to be transmitted/received includes e-mail. E-mail is an electronic message exchanged through a network among electronic devices and is document data including a destination mail address indicative of a destination, a source mail address indicative of a creator (sender), a mail title (subject), and body text. E-mail is exchanged along with information, for example, image data or audio data, attached thereto (attached data) in some cases. The information such as image data or audio data is related data related to document data of e-mail and corresponds to related data of the present invention.

The displaying device 16 is a device that optically displays settings and execution results of the various programs for allowing the electronic control apparatus 12 to implement the various functions, for example, and is made up of a display device, for example.

The input device 18 includes keyboard and mouse accepting input from a user, for example, and an information reader such as a CD-ROM drive or a card reader accepting input of information by reading information stored in a storage medium represented by CD-ROM and a memory card, for example. The information input through the information reader includes document data including word processing data and HTML (Hypertext Markup Language) data created by a computer having a document creation function, for example. The document data is made related to information, for example, image data or audio data in some cases. The information such as image data or audio data is related data related to the document data and corresponds to related data in the present invention.

The storage device 20 stores, for example, the various programs, information about the e-mail, information input from the information reader, and information created by the computer 10 and is made up of a hard disc device or a flash memory device, for example.

In FIG. 2, an e-mail transmission/reception control portion 24 is a so-called mailer that control transmission and reception of e-mail by the computer 10. The e-mail transmission/reception control portion 24 transmits e-mail created, for example, in accordance with input operation through the keyboard, etc., through the communication line 22 to an e-mail server apparatus not depicted. The transmitted e-mail is transmitted by the e-mail server apparatus to a destination electronic device. The e-mail transmission/reception control portion 24 receives e-mail transmitted from another electronic device to the computer 10.

The storage device 20 includes an e-mail data storage portion 26, a frequency storage portion 30, an unusable word storage portion 32, and an image data information storage portion 33.

The e-mail data storage portion 26 stores information about the transmitted/received e-mail and stores, for example, received e-mail, e-mail saved as a draft, and transmitted e-mail. The information about e-mail includes document data including a mail title and body text of e-mail and related data, for example, image data related to the document data.

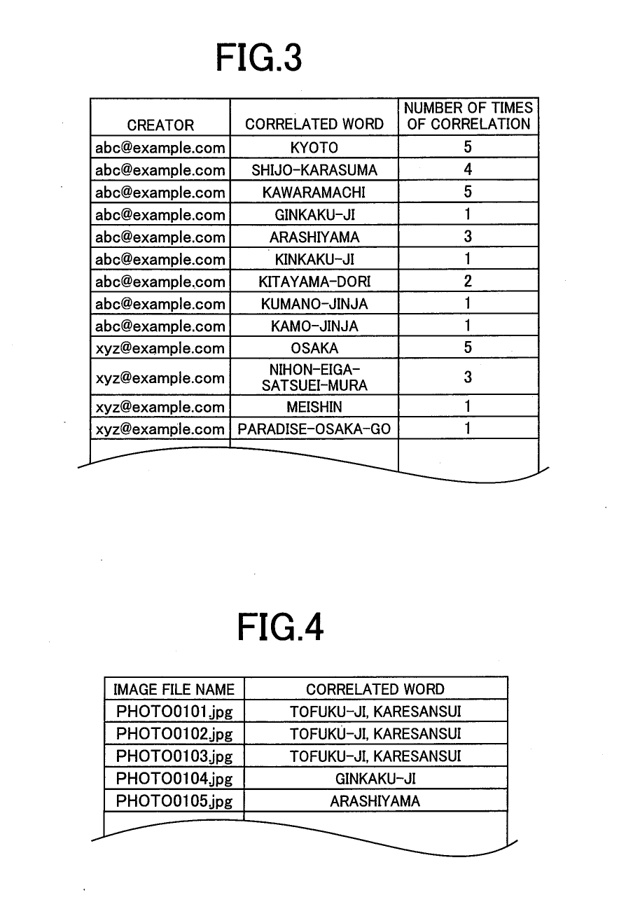

The frequency storage portion 30 stores information about the number of times that a word extracted by a word extracting portion 34 described later is correlated with image data that is an example of the related data by a correlating portion 38 described later, i.e., the number of times of correlation, for each word. The frequency storage portion 30 is a frequency information database that stores information about the number of times of the correlation, which corresponds to information about frequency in the present invention. FIG. 3 depicts an example of information about the number of times of the correlation stored in the frequency storage portion 30. As depicted in FIG. 3, the frequency storage portion 30 stores the information about the number of the correlation of each word for each creator of document data that is a source of extraction of the word. If document data is included in e-mail, a source mail address of e-mail may be used as the information indicative of the creator of the document data as depicted in FIG. 3. The frequency storage portion 30 corresponds to a frequency storage portion of the data managing program for driving the computer to act as the data managing apparatus in the present invention.

The unusable word storage portion 32 stores predetermined information of words not used for the correlation with the image data by the correlating portion 38 described later, i.e., unusable words.

The image data information storage portion 33 stores information about the words correlated with the image data by the correlating portion 38 described later and the image data. The image data information storage portion 33 is a related data information database that stores information about the image data that is an example of the related data and the words correlated therewith. FIG. 4 exemplarily illustrates a portion of information about the image data and the words correlated therewith respectively stored in the image data information storage portion 33. In this embodiment, as depicted in FIG. 4, a file name of image data and a word correlated with the image data are paired and stored as character data in the image data information storage portion 33.

The word extracting portion 34 extracts one or a plurality of words from document data made related to image data among the document data stored in the storage device 20. Specifically, the word extracting portion 34 includes a morpheme analyzer (morpheme analyzing program) represented by, for example, ChaSen and MeCab, for dividing sentences included in input document data into words and imparting word classes and a morpheme analysis dictionary represented by, for example, UniDic or IPAdic as a dictionary used when the morpheme analyzer analyzes the document data and uses the morpheme analyzer and the morpheme analysis dictionary to extract words corresponding to proper nouns and words corresponding to certain common nouns. For example, the word extracting portion 34 extracts words included in body text of an e-mail having attached image data among e-mails stored in the e-mail data storage portion 26 and extracts words corresponding to proper nouns and words corresponding to certain common nouns among the words based on the word class information imparted by the morpheme analyzer. The words corresponding to the certain common nouns are words corresponding to the common nouns determined as useful markers for searching image data, which are stored in the storage device 20, etc., in advance. In this embodiment, the word extracting portion 34 executes the process of extracting words (word extraction process) each time the e-mail data storage portion 26 stores document data made related to image data. The word extracting portion 34 corresponds to a word extracting portion of the data managing program for driving the computer to act as the data managing apparatus in the present invention.

An infrequently-appearing word selecting portion 36 selects a word having the number of times that the word is correlated with image data by the correlating portion 38 described later, i.e., the number of times of correlation lower than a given threshold value predetermined among the words extracted by the word extracting portion 34 based on the information stored in the frequency storage portion 30 as an infrequently-appearing word. If a corresponding word is not registered in the information stored in the frequency storage portion 30, the number of times of correlation of the word is considered to be zero. Although the threshold value is set to, for example, five in this embodiment, a user may arbitrarily change this value. The infrequently-appearing word selecting portion 36 corresponds to an infrequently-appearing word selecting portion of the data managing program for driving the computer to act as the data managing apparatus in the present invention.

The correlating portion 38 correlates an infrequently-appearing word selected by the infrequently-appearing word selecting portion 36 among the words extracted from the document data by the word extracting portion 34 with the image data related to the document data. The correlating portion 38 performs the correlation with the image data by using a word other than the words stored in the unusable word storage portion 32. The correlating portion 38 of this embodiment correlates a word selected as an infrequently-appearing word by the infrequently-appearing word selecting portion 36 and not corresponding to a word stored in the unusable word storage portion 32 with the image data related to the document data that is the source of extraction of the word. If no word is selected as an infrequently-appearing word by the infrequently-appearing word selecting portion 36 among the words extracted from the document data by the word extracting portion 34, the correlating portion 38 correlates a word not selected as an infrequently-appearing word by the infrequently-appearing word selecting portion 36, i.e., a frequently appearing word having the number of times of correlation equal to or greater than the given threshold value among the words extracted from the document data by the word extracting portion 34 with the image data related to the document data. In this embodiment, when the infrequently-appearing word selecting portion 36 executes the infrequently-appearing word selecting process, the correlating portion 38 executes the process of correlating a word selected by the process with the image data (correlation process). The correlating portion 38 corresponds to a correlating portion of the data managing program for driving the computer to act as the data managing apparatus in the present invention.

To correlate the word with the image data, a word desired to be correlated and a file name of the image data related to the extraction source document data of the word are paired as depicted in FIG. 4, for example, and stored in the image data information storage portion 33 in this embodiment.

A frequency updating portion 40 updates the information about the number of times of correlation stored in the frequency storage portion 30 in accordance with correlation by the correlating portion 38. Specifically, the frequency updating portion 40 determines whether a word correlated with image data by the correlating portion 38 is a word unregistered in the frequency storage portion 30. If the determination is affirmed, the word is newly registered in the frequency storage portion 30. If the determination is denied, the information about the number of times of correlation of the word stored in the frequency storage portion 30 is updated.

An input accepting portion 42 accepts input from a keyboard, a mouse, etc., of the input device 18, for example. For example, it is determined whether a search keyword used in an image data searching portion 44 described later is input and, if the determination is affirmed, the input of the search keyword is accepted. The search keyword is directly input from the keyboard in this embodiment.

Based on the ground that the search keyword accepted by the input accepting portion 42 is identical or similar to a word correlated with image data stored in the storage device 20, the image data searching portion 44 extracts the image data correlated with the identical or similar word as a search result on the basis of the information stored in the image data information storage portion 33. In this embodiment, for example, based on information of a plurality of words stored with degrees of similarity to a plurality of words, i.e., similarity degrees defined in advance, if it is determined that a similarity degree of the correlated word to a search keyword exceeds a predetermined similarity degree, the search keyword is considered to be similar to the correlated word. The image data searching portion 44 corresponds to a related data searching portion in the present invention.

A displaying portion 46 causes the displaying device 16 to display settings and execution results of the various programs. For example, the displaying portion 46 causes the displaying device 16 to display an e-mail creating screen, an e-mail viewing screen, a display screen for a search keyword accepted by the input accepting portion 42, a display screen of a search result of the image data searching portion 44, etc.

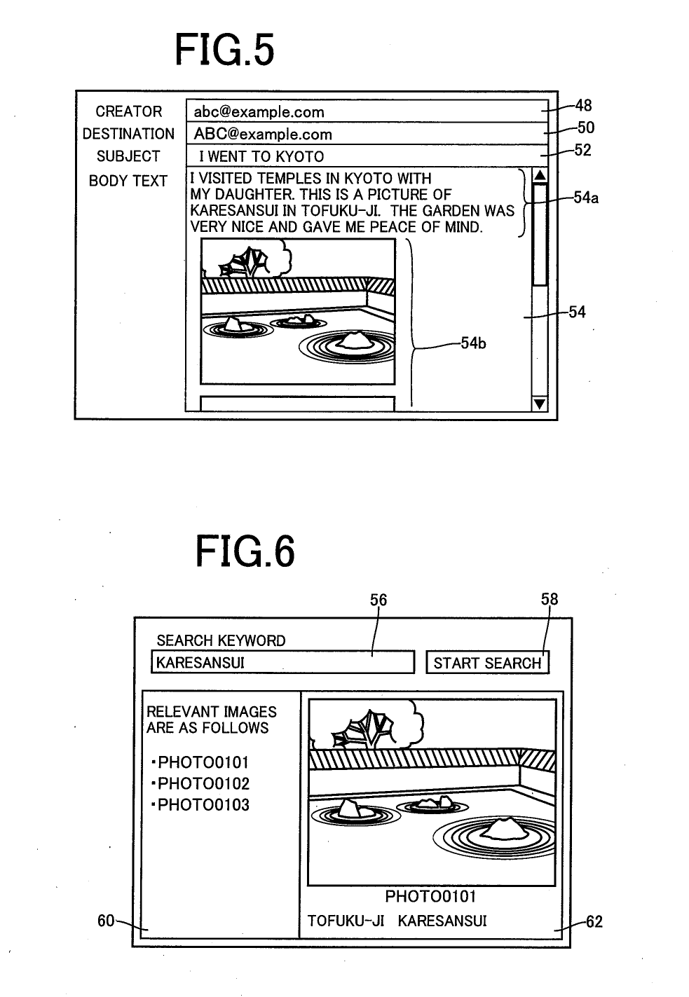

In FIG. 5, a sender field 48 displays a source mail address; a destination field 50 displays a destination mail address; a subject field 52 displays a mail title (subject); and a body text field 54 displays body text 54a and attached image data 54b.

In FIG. 6, a search keyword field 56 displays a search keyword accepted by the input accepting portion 42. The image data searching portion 44 of this embodiment performs the search if a search keyword is input into the search keyword field 56 and the initiation of the search is signaled by pressing down a search initiating button 58, for example. A search result field 60 displays a search result of the image data searching portion 44, i.e., whether the search keyword input in the search keyword field 56 is identical or similar to any one of the words correlated to the image data stored in the storage device 20. If identical or similar, a list of file names of the image data correlated with the identical or similar word is displayed along with, for example, a comment such as “relevant images are as follows”. The displaying portion 46 determines whether one image data is selected from the displayed list of file names of the image data. If selected, the image of the selected image data and the word correlated with the selected image data are displayed together on a selected file display field 62.

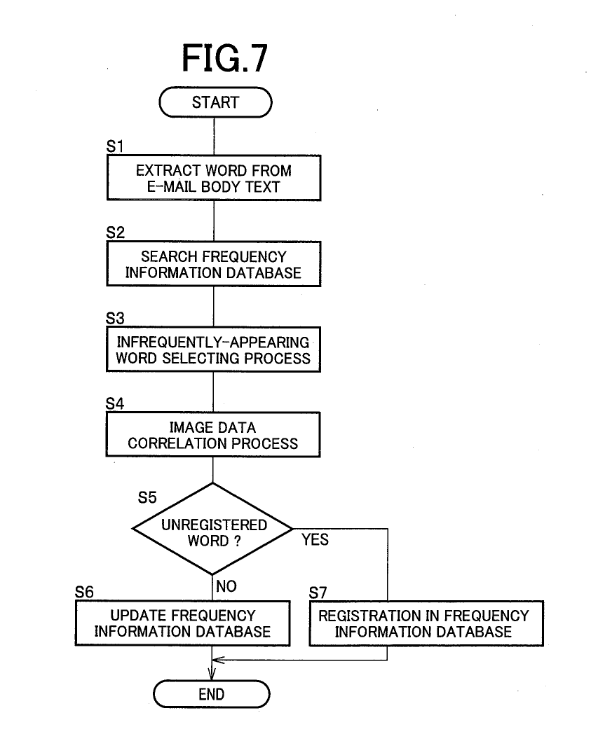

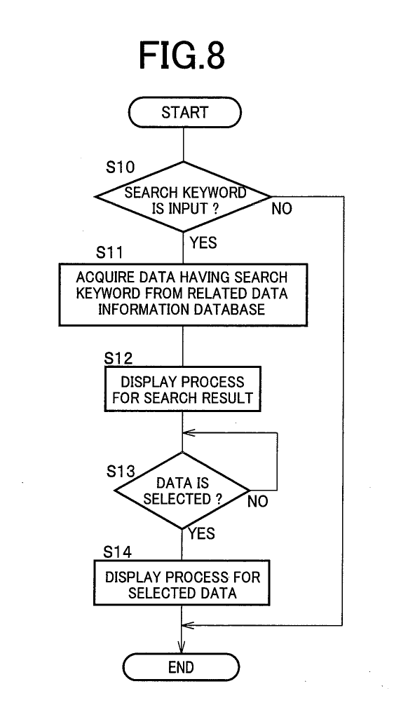

FIGS. 7 and 8 are flowcharts for explaining a relevant part of the control operation of the electronic control device 12, i.e., the control operation for driving the computer 10 to act as the data managing apparatus by executing the data managing program stored in the ROM of the electronic control device 12, for example. First, the flowchart of FIG. 7 will be described.

The flowchart depicted in FIG. 7 is executed in this embodiment, for example, when an e-mail is received along with attached image data and the information of the e-mail is stored in the e-mail data storage portion 26.

In FIG. 7, at step (hereinafter, “step” will be omitted) S1 corresponding to the word extracting portion 34 and a word extracting step of the present invention, the CPU extracts one or a plurality of words from document data that triggers the execution of the flowchart. For example, words included in the e-mail body text corresponding to the document data are identified and words corresponding to proper nouns and words corresponding to certain common nouns are extracted from the words based on the word class information imparted by the morpheme analyzer.

At S2 corresponding to the infrequently-appearing word selecting portion 36 and an infrequently-appearing word selecting step of the present invention, the CPU checks the numbers of times of correlation that the words extracted at S1 are correlated to image data up to this time based on the information stored in the frequency storage portion 30.

At S3 corresponding to the infrequently-appearing word selecting portion 36 and the infrequently-appearing word selecting step of the present invention, the CPU selects words having the number of times of correlation lower than a given threshold value predetermined among the words as infrequently-appearing words based on the number of times of the correlation of each word checked at S2. In this embodiment, the threshold value is set to five, for example.

At S4 corresponding to the correlating portion 38 and a correlating step of the present invention, the CPU correlates a word not identical to an unusable word stored in the unusable word storage portion 32 among the infrequently-appearing words selected at S3 with the image data attached to the extraction source e-mail of the word. In this embodiment, as depicted in FIG. 4, the word and the file name of the image data are paired and stored as character data in the image data information storage portion 33.

If no word is selected as an infrequently-appearing word at S3 among the words extracted from the document data at S1 and if all the words selected as infrequently-appearing words at S3 are identical to the words stored in the unusable word storage portion 32, the CPU correlates a word not selected as an infrequently-appearing word at S3 among the words extracted at S1 with the image data. In the above case, a frequently-appearing word having the number of times of correlation equal to or greater than five is correlated with the image data among the words extracted at S1. For example, all the frequently-appearing words are correlated in this embodiment.

At S5 corresponding to the frequency updating portion 40 and a frequency updating step of updating storage contents of a frequency storage step of the present invention, the CPU determines whether a word correlated to image data at S4 is a word unregistered in the frequency storage portion 30.

If the determination at S5 is denied, at S6 corresponding to the frequency updating portion 40 and the frequency updating step of the present invention, the CPU updates the information about the number of times of the correlation of the word correlated with the image data at S4 to terminate the execution of this routine.

If the determination at S5 is affirmed, at S7 corresponding to the frequency updating portion 40 and the frequency updating step of the present invention, the CPU registers into the frequency storage portion 30 the information about the number of times of the correlation of the word correlated with the image data at S4 to terminate the execution of this routine.

The control operation of the electronic control device 12 will be described for the case that the e-mail depicted in FIG. 5 is received and the information about the e-mail is stored in the e-mail data storage portion 26. It is assumed that, for example, information about the number of times of the correlation depicted in FIG. 3 is stored in the frequency storage portion 30 when the e-mail is received.

The text of the e-mail of FIG. 5, i.e., the body text 54a is “I visited temples in Kyoto with my daughter. This is a picture of Karesansui in Tofuku-ji. The garden was very nice and gave me peace of mind”. This e-mail has the three attached image data 54b including the image displayed in the body text field 54 of FIG. 5. When such an e-mail is received, first, at the time of the execution of S1 of the flowchart of FIG. 7, “Kyoto”, “Tofuku-ji”, and “Karesansui” are extracted as words corresponding to proper nouns and certain common nouns included in the body text 54a of the e-mail.

At S2 of FIG. 7, the numbers of times of correlation “5”, “0”, and “1” are retrieved for “Kyoto”, “Tofuku-ji”, and “Karesansui”, respectively, based on the information corresponding to a creator “abc@example.com”, which is the sender of the e-mail of FIG. 5, in the information about the number of times of the correlation depicted in FIG. 3.

At S3 of FIG. 7, among the retrieved “Kyoto”, “Tofuku-ji”, and “Karesansui”, the words “Tofuku-ji” and “Karesansui” are selected as infrequently-appearing words since the numbers of times of correlation are less than a given threshold value, for example, five.

At S4 of FIG. 7, “Tofuku-ji” and “Karesansui” selected as the infrequently-appearing words are paired with file names “PHOTO0101.jpg”, “PHOTO0102.jpg”, and “PHOTO0103.jpg” of three image data attached to the e-mail and stored as character data in the image data information storage portion 33 as depicted in FIG. 4.

At S7 of FIG. 7, the information about the numbers of times of correlation of “Tofuku-ji” and “Karesansui” selected as the infrequently-appearing words at S3 is updated for each creator of document data, i.e., for each sender of e-mail. Specifically, it is determined at S5 of FIG. 7 that “Tofuku-ji” and “Karesansui” are words unregistered in the frequency storage portion 30 and, at S7 of FIG. 7, the information of the numbers of the times of correlation of “Tofuku-ji” and “Karesansui” is registered as “1” in the frequency storage portion 30.

Such a process is executed each time information about e-mail is stored in the storage device 20, i.e., each time e-mail is received. As a result, for example, the predetermined process is executed for an e-mail received subsequently to the e-mail depicted in FIG. 5 and a file name “PHOTO0104.jpg” of a given image data attached to the e-mail and “Ginkaku-ji” are paired and stored as character data in the image data information storage portion 33 as depicted in FIG. 4. Then the predetermined process is executed for an e-mail received followingly and a file name “PHOTO0105.jpg” of a given image data attached to the e-mail and “Arashiyama” are paired and stored as character data in the image data information storage portion 33.

The flowchart of FIG. 8 will then be described. The flowchart depicted in FIG. 8 is repeatedly executed at extremely short cycle times, for example, on the order of few msec to a few tens of msec.

In FIG. 8, at S10 corresponding to the input accepting portion 42, the CPU determines whether a search keyword is input from, for example, keyboard and mouse of the input device 18.

If the determination at S10 is denied, the CPU terminates the execution of this routine, and if the determination is affirmed, at S11 corresponding to the image data searching portion 44, based on the ground that the search keyword accepted by the input accepting portion 42 is identical or similar to a word correlated with image data stored in the storage device 20, the CPU extracts the image data correlated with the identical or similar word as a search result on the basis of the information stored in the image data information storage portion 33.

At S12 corresponding to the image data searching portion 44, the CPU displays the search result of S11 on a display device, etc., of the displaying device 16, for example. For example, the display device of the displaying device 16 displays whether the identical or similar image data is extracted as the search result and, for example, a list of file names or thumbnail images of the image data if extracted.

At S13 corresponding to the displaying portion 46, the CPU determines whether one image data is selected from the list of file names, etc., of the image data displayed on the display device, etc., at S12, for example.

If the determination at S13 is denied, the CPU repeatedly executes S13 or later. However, if the determination is affirmed, at S14 corresponding to the displaying portion 46, the CPU displays the image selected from the list of the file names, etc., of the image data and the word correlated with the selected image together on the display device, etc., to terminate the execution of this routine.

The control operation of the electronic control device 12 will specifically be described for the case of searching image data corresponding to a word identical or similar to a desired search keyword from the image data stored in the storage device 20. It is assumed that the image data information storage portion 33 stores information about image data and words correlated therewith partially depicted in FIG. 4 at the time of the search of the image data.

If “Karesansui” is input into the search keyword field 56 on the display screen depicted in FIG. 6 displayed on the displaying device 16 by executing a predetermined process, it is determined that a search keyword “Karesansui” is input at S10 of FIG. 8.

If the initiation of the search is signaled in such a way as pressing down the search initiating button 58 of the display screen of FIG. 6, the image data “PHOTO0101.jpg”, “PHOTO0102.jpg”, and “PHOTO0103.jpg” are extracted as a search result at S11 of FIG. 8 based on the ground that the search keyword “Karesansui” is identical or similar at a similarity degree higher than a predetermined similarity degree to the word correlated with the image data stored in the storage device 20.

At S12 of FIG. 8, a list of file names of the image data “PHOTO0101.jpg”, “PHOTO0102.jpg”, and “PHOTO0103.jpg” is displayed along with a comment “relevant images are as follows” in the search result field 60 on the display screen of FIG. 6.

If one image data is selected from the list of file names displayed in the search result field 60, the determination at S13 of FIG. 8 is affirmed and the image of the selected image data, the file name of the image data, and the words correlated with the image data are displayed together in the selected file display field 62 on the screen display of FIG. 6 at S14 of FIG. 8.

As described above, according to this embodiment, since the correlating portion 38 correlates an infrequently-appearing word having the number of times of correlation of the word lower than a given threshold value predetermined, for example, five, among the words extracted from document data by the word extracting portion 34, with the image data (related data) related to the document data, the infrequently-appearing word having the number of times of correlation equal to or less than five is used as the word correlated with the image data and, therefore, a word suitable for a marker can be correlated with the image data automatically, i.e., without the need for operation by an operator.

Since the infrequently-appearing word selecting portion 36 selects an infrequently-appearing word having the number of times of correlation that the word is correlated with image data by the correlating portion 38 lower than a given threshold value, for example, five, among the words extracted by the word extracting portion 34 based on the information stored in the frequency storage portion 30, the infrequently-appearing word having the number of times of correlation equal to or less than five is used as the word correlated with the image data and, therefore, a word suitable for a marker can automatically be correlated with the image data.

Since the word extracting portion 34 extracts words corresponding to proper nouns and words corresponding to certain common nouns from document data, the words correlated with image data do not include those other than the words corresponding to proper nouns and the words corresponding to certain common nouns and, therefore, a word suitable for a marker can automatically be correlated with the image data.

Since the correlating portion 38 uses words other than the words stored in the unusable word storage portion 32 to perform the correlation with image data, the words correlated with the image data does not include unusable words and, therefore, a word suitable for a marker can automatically be correlated with the image data.

Since if no word is selected as an infrequently-appearing word by the infrequently-appearing word selecting portion 36 among the words extracted from the document data by the word extracting portion 34, the correlating portion 38 correlates a word not selected as the infrequently-appearing word by the infrequently-appearing word selecting portion 36 with the image data related to the document data, a situation can be prevented that no word is correlated with image data.

Since the frequency storage portion 30 stores information about the number of times (frequency) of the correlation for each creator of the document data and the infrequently-appearing word selecting portion 36 selects an infrequently-appearing word from the words extracted from document data by the word extracting portion 34 based on the information corresponding to the creator of the document data out of the information stored in the frequency storage portion 30, the word correlated with the image data is a word having the number of times of the correlation of the word stored for each creator of document data less than a given threshold value and, therefore, a word suitable for a marker can automatically be correlated with the image data.

Due to the inclusion of the input accepting portion 42 that accepts input of a search keyword and the image data searching portion 44 that extracts image data as a search result based on the ground that a search keyword accepted by the input accepting portion 42 is identical or similar to a word correlated with the image data stored in the storage device 20, the image data can be searched that is correlated with a word identical or similar to a desired search keyword among the image data stored in the storage device 20.

Since the data managing method includes a correlating step of correlating an infrequently-appearing word having the frequency of the word lower than a given threshold value predetermined among the words extracted from document data at a word extracting step with image data related to the document data, a word having the frequency less than the given threshold value is used for the word correlated with the related data and, therefore, a word suitable for a marker can automatically be correlated with the image data.

### Second Embodiment

Another embodiment of the present invention will be described. In the following description of the embodiment, the portions overlapping with the embodiment described above are denoted by the same reference numerals and will not be described.

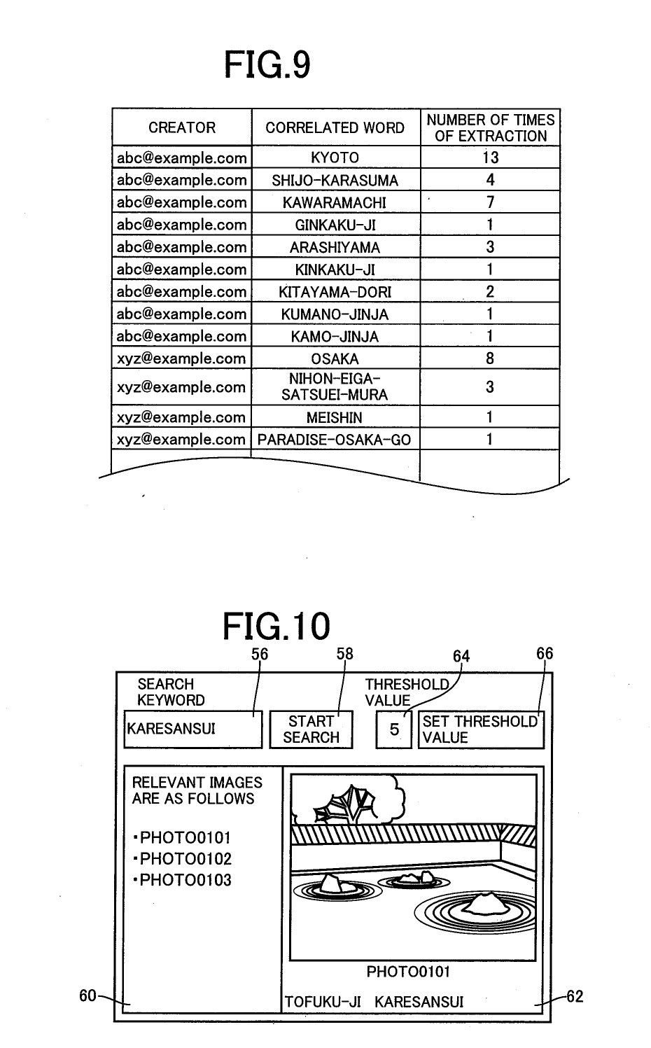

In FIG. 2, the frequency storage portion 30 in this embodiment stores information about the number of times that a certain word is extracted by the word extracting portion 34 described later, i.e., the number of times of extraction, for each word. The frequency storage portion 30 is a frequency information database that stores information about the number of times of the extraction, which corresponds to information about the frequency in the present invention. FIG. 9 depicts an example of information about the number of times of the extraction stored in the frequency storage portion 30, corresponding to FIG. 3 of the first embodiment. The information about the number of times of the extraction for each word stored in the frequency storage portion 30 is stored for each creator of document data that is a source of extraction of the word as described above.

The frequency updating portion 40 of this embodiment updates the information about the number of times of extraction stored in the frequency storage portion 30 in accordance with extraction of a word by the word extracting portion 34. Specifically, the frequency updating portion 40 determines whether a word extracted by the word extracting portion 34 is a word unregistered in the frequency storage portion 30. If the determination is affirmed, the word is newly registered in the frequency storage portion 30. If the determination is denied, the number of times of extraction of the word stored in the frequency storage portion 30 is updated.

The infrequently-appearing word selecting portion 36 of this embodiment selects a word having the number of times of extraction lower than a given threshold value predetermined among the words extracted by the word extracting portion 34 based on the information stored in the frequency storage portion 30 as an infrequently-appearing word. Although the threshold value is set to, for example, five in this embodiment, a user may arbitrarily change this value. FIG. 10 is a diagram corresponding to FIG. 6 of the first embodiment. In this embodiment, the threshold value is set to a certain value by inputting a certain value into a threshold value input field 64 and pressing down a threshold value setting button 66. In this embodiment, when the image data searching portion 44 searches image data stored in the storage device 20, the infrequently-appearing word selecting portion 36 executes the process of selecting the infrequently-appearing word (infrequently-appearing word selecting process) before the search. Specifically, for example, the infrequently-appearing word selecting process is executed immediately after the process of setting the threshold value is executed.

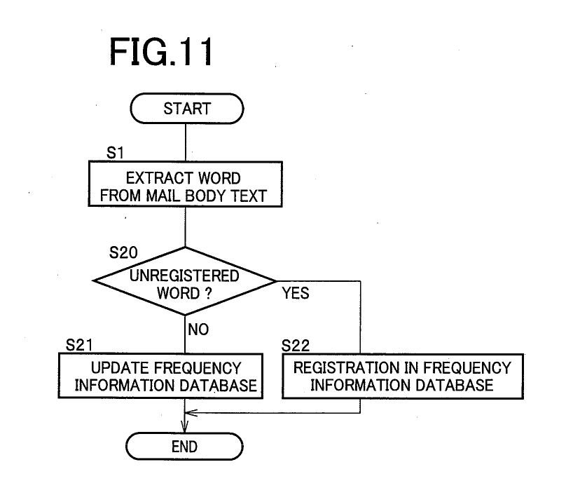

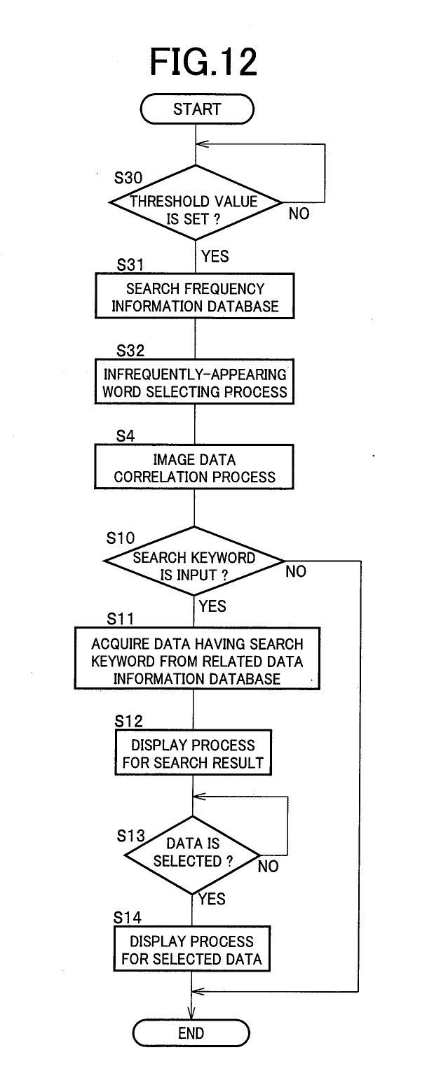

FIGS. 11 and 12 are flowcharts for explaining a relevant part of the control operation of the electronic control device 12, i.e., the control operation for driving the computer 10 to act as the data managing apparatus by executing the data managing program stored in the ROM of the electronic control device 12, for example. First, the flowchart of FIG. 11 will be described.

The flowchart depicted in FIG. 11 is executed in this embodiment, for example, when an e-mail is received along with attached image data and the information of the e-mail is stored in the e-mail data storage portion 26. The details of execution at step S1 of FIG. 11 are the same as FIG. 7 of the embodiment.

At S20 corresponding to the frequency updating portion 40, the CPU determines whether a word extracted at S1 is a word unregistered in the frequency storage portion 30.

If the determination at S20 is denied, at S21 corresponding to the frequency updating portion 40, the CPU updates the information about the number of times of the extraction of the word extracted at S1 to terminate the execution of this routine.

If the determination at S20 is affirmed, at S22 corresponding to the frequency updating portion 40, the CPU registers into the frequency storage portion 30 the information about the number of times of the extraction of the word extracted at S1 to terminate the execution of this routine.

The control operation of the electronic control device 12 will be described for the case that the e-mail depicted in FIG. 5 is received and the information about the e-mail is stored in the e-mail data storage portion 26. It is assumed that, for example, information about the number of times of the extraction depicted in FIG. 9 is stored in the frequency storage portion 30 when the e-mail is received.

When the e-mail depicted in FIG. 5 is received, first, at the time of the execution of S1 of the flowchart of FIG. 11, “Kyoto”, “Tofuku-ji”, and “Karesansui” are extracted as words corresponding to proper nouns and certain common nouns included in the body text 54a.

At S20 of FIG. 7, the information about the numbers of times of extraction of the extracted words “Kyoto”, “Tofuku-ji”, and “Karesansui” is updated for each creator of document data, i.e., for each sender of e-mail. Specifically, the number of times of extraction is updated from “13” to “14” for the extracted word “Kyoto” of the creator field “abc@example.com” in FIG. 9; the extracted word “Tofuku-ji” is newly registered with the number of times of extraction registered as “1”; and the extracted word “Karesansui” is newly registered with the number of times of extraction registered as “1”.

Such a process is executed each time information about e-mail is stored in the storage device 20, i.e., each time e-mail is received.

The flowchart of FIG. 12 will then be described. The flowchart depicted in FIG. 12 is repeatedly executed at extremely short cycle times, for example, on the order of few msec to a few tens of msec.

At S30 corresponding to the infrequently-appearing word selecting portion 36, the CPU determines whether a process of setting the threshold value to a certain value is executed by inputting a certain value into the threshold value input field 64 of the display screen depicted in FIG. 10 and pressing down the threshold value setting button 66.

If the determination at S30 is denied, the CPU repeatedly executes S30 and, if the determination is affirmed, at S31 corresponding to the infrequently-appearing word selecting portion 36, the CPU executes the process of setting the threshold value and subsequently searches a word having the number of times of the extraction equal to or lower than the threshold value based on the information about the number of times of extraction for each word stored in the frequency storage portion 30. In this embodiment, the threshold value is set to five, for example.

At S32 corresponding to the infrequently-appearing word selecting portion 36, the CPU selects a word having the number of times of extraction lower than the threshold value set at S31 among the words stored in the frequency storage portion 30 as an infrequently-appearing word based on the number of times of extraction for each word searched at S31.

The details of execution at S4 and S10 to S14 of FIG. 12 are the same as the details of execution of S4 and S10 to S14, respectively, of FIG. 7.

The control operation of the electronic control device 12 will specifically be described for the case of correlating proper words with image data stored in the storage device 20 and searching image data corresponding to a word identical or similar to a desired search keyword from the image data.

If, for example, “5” is input into the threshold value input field 64 and the threshold value setting button 66 is pressed down on the display screen as depicted in FIG. 10 displayed on the displaying device 16 by performing a predetermined operation of activating image search software, the determination at S30 of FIG. 12 is affirmed.

At S31 of FIG. 12, the threshold value is set to five. A search is then performed for the information about the number of times of extraction for each word stored in the frequency storage portion 30.

At S32 of FIG. 12, among the extracted words depicted in FIG. 9, the words having the number of times of extraction equal to or lower than five are selected as infrequently-appearing words, which are “Shijo-karasuma”, “Ginkaku-ji”, “Arashiyama”, “Kinkaku-ji”, “Kitayama-dori”, “Kumano-jinja”, “Kamo-jinja”, “Nihon-eiga-satsuei-mura”, “Meisin”, and “Paradise-Osaka-go”.

At S4 of FIG. 12, the information about the words selected as the infrequently-appearing words is embedded respectively as tag information in the image data related to the document data that are the extraction sources of the words. Each of the file names of the image data and each of the words selected as the infrequently-appearing words are paired and stored as character data in the image data information storage portion 33 as partially depicted in FIG. 4.

If “Karesansui” is input into the search keyword field 56 on the display screen of FIG. 10 displayed on the displaying device 16, it is determined that a search keyword “Karesansui” is input at S10 of FIG. 12.

If the initiation of the search is signaled in such a way as pressing down the search initiating button 58 of the display screen of FIG. 10, the image data “PHOTO0101.jpg”, “PHOTO0102.jpg”, and “PHOTO0103.jpg” are extracted as a search result at S11 of FIG. 12 based on the ground that the search keyword “Karesansui” is identical or similar to the word correlated with the image data stored in the storage device 20.

At S12 of FIG. 12, a list of file names of the image data “PHOTO0101.jpg”, “PHOTO0102.jpg”, and “PHOTO0103.jpg” is displayed along with a comment “relevant images are as follows” in the search result field 60 on the display screen of FIG. 10.

If one image data is selected from the list of file names displayed in the search result field 60, the determination at S13 of FIG. 12 is affirmed and the image of the selected image data, the file name of the image data, and the words correlated with the image data are displayed together in the selected file display field 62 on the screen display of FIG. 10 at S14 of FIG. 12.

As described above, although this embodiment includes the infrequently-appearing word selecting process by the infrequently-appearing word selecting portion 36 and the correlating process by the correlating portion 38 executed at timings different from the first embodiment and this embodiment is different from the first embodiment in that the frequency storage portion 30 stores information about the number of times of extraction for each word corresponding to the frequency of the present invention, since other configurations are the same as the first embodiment, a word suitable for a marker can be correlated with the image data automatically, i.e., without the need for operation by an operator as is the case with the first embodiment.

Although some embodiments of the present invention have been described in detail with reference to the drawings, the present invention is not limited to these embodiments and may be implemented in another aspect.

For example, although the frequency storage portion 30 stores the information about the number of times that a word is correlated with image data by the correlating portion 38 or the information about the number of times that a word is extracted from document data by the word extracting portion 34 for each word in the embodiments, this is not a limitation. The frequency storage portion 30 may basically be any portion that stores information about frequency of each word. The information of frequency includes, for example, a rate of the number of times that a given word is extracted by the word extracting portion 34 relative to the total number of extraction, a rate of the number of times that a given word is extracted by the word extracting portion 34 relative to the largest number of times of extraction among the numbers of times of extraction of all the words, a difference between the largest number of times of extraction among the numbers of times of extraction of all the words and the number of times that a given word is extracted by the word extracting portion 34, a difference between the number of times that a given word is extracted by the word extracting portion 34 and the number of times that the given word is correlated with image data by the correlating portion 38, and a rate of the number of times that a given word is correlated with image data by the correlating portion 38 relative to the number of times that the given word is extracted by the word extracting portion 34, other than those above.

Although the frequency storage portion 30 stores either the information about the number of times that a word is correlated with image data by the correlating portion 38 or the information about the number of times that a word is extracted from document data by the word extracting portion 34 in the embodiments, the information about a plurality of frequencies may be stored. The infrequently-appearing word selecting portion 36 may select an infrequently-appearing word based on the information about the plurality of frequencies. For example, the infrequently-appearing word selecting portion 36 may select a word having the number of times of extraction by the word extracting portion 34 lower than a given threshold value and the number of times of correlation by the correlating portion 38 lower than a given threshold value as an infrequently-appearing word.

Although a word desired to be correlated and a file name of image data related to the extraction source document data of the word are paired as depicted in FIG. 4, for example, and stored as character data in the image data information storage portion 33 to correlate a word with image data in the embodiments, this is not a limitation and, for example, information about a word desired to be correlated may be embedded in image data. Specifically, for example, the information about the word desired to be correlated may be stored in image data conforming to a standard such as Exif (exchangeable image file format) and including a storage area for information such as a shooting data and a shutter speed of the image, for example.

Although the word extracting portion 34 extracts words included in body text of e-mail stored in the e-mail data storage portion 26 in the embodiments, this is not a limitation and, for example, the storage device 20 may include a document data storage portion that stores document data input from the information reader, etc., or created by the compute 10 and the word extracting portion 34 may extract words included in document data made related to image data among the document data stored in the document data storage portion and may extract words corresponding to proper nouns and words corresponding to certain common nouns among the words based on the word class information imparted by the morpheme analyzer.

Although the word extracting portion 34 is configured to execute the word extracting process each time the storage device 20 stores document data in the embodiments, the word extracting portion 34 may execute the word extracting process, for example, each time a user executes a predetermined operation, or at predetermined time intervals, or each time a search for image data (related data) is performed, for example. In the case that the word extracting process is executed each time the search for an image file is performed, the word extracting process may be executed immediately after the search. If the word extracting process is executed after the search for image data, since the word extracting process has never been executed at the time of a first search for image data and no word has been correlated with the image data of the storage device 20, the word extracting process may be configured to be executed immediately before the search only at the time of the first search, for example.

Although the infrequently-appearing word selecting portion 36 is configured to executed the infrequently-appearing word selecting process when the word extracting portion 34 executes the word extracting process or the process of setting the threshold value is executed in the embodiments, this is not a limitation. For example, the infrequently-appearing word selecting portion 36 may be configured to execute the infrequently-appearing word selecting process when a user performs a predetermined operation or at another predetermined timing. For example, the infrequently-appearing word selecting portion 36 may be configured to execute the infrequently-appearing word selecting process before the search for image data executed by the image data searching portion 44 or after the search. If the infrequently-appearing word selecting process is executed after the search for image data, since the infrequently-appearing word selecting process has never been executed at the time of the first search for image data and no word has been correlated with the image data of the storage device 20, initial information about infrequently-appearing words may be set and stored in advance to execute the correlating process based on the initial information or the infrequently-appearing word selecting process may be configured to be executed immediately before the search only at the time of the first search, for example.

Although the correlating portion 38 executes the correlating process when the infrequently-appearing word selecting portion 36 executes the infrequently-appearing word selecting process in the embodiments, this is not a limitation. For example, the correlating portion 38 may be configured to execute the correlating process when a user performs a predetermined operation or at another predetermined timing. For example, the correlating portion 38 may be configured to execute the correlating process before the search for image data executed by the image data searching portion 44 or after the search. If the correlating process is executed after the search for image data, since no word has been correlated with the image data of the storage device 20 at the time of the first search for image data, the correlating process may be configured to be executed immediately before the search only at the time of the first search, for example.

In the embodiments, the threshold value used in the infrequently-appearing word selecting portion 36 is not limited to five and another value may be set.

Although if extraction is performed from e-mail stored in the e-mail data storage portion 26, the word extracting portion 34 extracts words included in the body text of the e-mail in the embodiments, this is not a limitation and the extraction may be performed from a mail title, for example.

Although the word extracting portion 34 includes the morpheme analyzer and the morpheme analysis dictionary in the embodiments, the word extracting portion 34 may include, for example, a morpheme analysis tool represented by KAKASI, etc., including functions of both the morpheme analyzer and the morpheme analysis dictionary. The morpheme analyzer and the morpheme analysis dictionary are not limited to those exemplarily illustrated in the embodiments.

Although the word extracting portion 34 extracts words corresponding to proper nouns and words corresponding to certain common nouns in the embodiments, this is not a limitation and various aspects are available such as those extracting word corresponding only to proper nouns or those extracting all the proper nouns and common nouns.

Although the word extracting portion 34 extracts words from document data related to image data and the correlating portion 38 correlates infrequently-appearing words selected by the infrequently-appearing word selecting portion 36 with the image data in the embodiments, this is not a limitation. The word extracting portion 34 may extracts words from document data related to, for example, related data of another data format such as audio data other than image data, and the correlating portion 38 may correlate infrequently-appearing words selected by the infrequently-appearing word selecting portion 36 with the related data such as audio data.

Although the e-mail data storage portion 26, the frequency storage portion 30, the unusable word storage portion 32, and the image data information storage portion 33 are separately provided in the storage device 20 in the embodiments, this is not a limitation and, for example, the storage portion may collectively be provided in the storage device 20. Pieces of the information stored in the storage portion may be stored in an undifferentiated manner in a storage area provided in the storage device 20.

Although a search keyword is directly input from, for example, a keyboard in the embodiments, various aspects are available and, for example, a list of infrequently-appearing words selected by the infrequently-appearing word selecting portion may be created in such a way that a desired word is selected as a search keyword from the list.

Although if no word is selected as an infrequently-appearing word by the infrequently-appearing word selecting portion 36 among the words extracted from the document data by the word extracting portion 34, the correlating portion 38 correlates with image data all the frequently-appearing words having the number of times of correlation equal to or greater than a given threshold value among the extracted words in the embodiments, the correlating portion 38 may be configured to correlate with image data the frequently-appearing word having the smallest number of times of correlation or a plurality of frequently-appearing words in ascending order of the number of times of correlation, for example.

Although the word information correlated with the image data is used for searching a desired image data from the image data stored in the storage device 20 in the embodiments, this is not a limitation and the word information may be used for other applications such as classifying the image data stored in the storage device 20 or being printed together with an image at the time of printing of the image data, for example.

Only some embodiments have been described and, although not exemplarily illustrated one by one, the present invention may be implemented in variously modified or altered manners based on the knowledge of those skilled in the art without departing from the spirit thereof.

1. A data managing apparatus having a word extracting portion that extracts one or a plurality of words from document data and a correlating portion that correlates the words extracted by the word extracting portion with related data related to the document data, comprising:
a frequency storage portion having information about a frequency of each of the words stored thereon for each word;
an infrequently-appearing word selecting portion that selects an infrequently-appearing word having the frequency lower than a given threshold value predetermined among the words extracted by the word extracting portion based on the information stored in the frequency storage portion; and
a frequency updating portion that updates the information about frequency stored in the frequency storage portion in accordance with extraction by the word extracting portion or correlation by the correlating portion,
the correlating portion correlating the infrequently-appearing word selected by the infrequently-appearing word selecting portion among the words extracted from the document data by the word extracting portion with the related data related to the document data.

2. The data managing apparatus of claim 1, wherein
the frequency stored in the frequency storage portion is a frequency that each word is correlated with the related data by the correlating portion, and wherein
the frequency updating portion updates the information about frequency stored in the frequency storage portion in accordance with the correlation by the correlating portion.

3. The data managing apparatus of claim 2, wherein
the frequency stored in the frequency storage portion is the number of times that each word is correlated with the related data by the correlating portion.

4. The data managing apparatus of claim 3, wherein
the infrequently-appearing word selecting portion selects an infrequently-appearing word having the number of times that the word is correlated with the related data by the correlating portion lower than a given threshold value predetermined among the words extracted by the word extracting portion based on the information stored in the frequency storage portion.

5. The data managing apparatus of claim 1, wherein
the frequency stored in the frequency storage portion is the number of times that each word is extracted by the Word extracting portion, and wherein
the frequency updating portion updates the information about frequency stored in the frequency storage portion in accordance with the extraction by the word extracting portion.

6. The data managing apparatus of claim 1, wherein the word extracting portion extracts proper nouns and certain common nouns from the document data.

7. The data managing apparatus of claim 1, comprising
an unusable word storage portion that stores predetermined information about words not used by the correlating portion for correlation with the related data, wherein
the correlating portion uses a word other than the words stored in the unusable word storage portion to perform correlation with related data.

8. The data managing apparatus of claim 1, wherein if no word is selected as the infrequently-appearing word by the infrequently-appearing word selecting portion among the words extracted from the document data by the word extracting portion, the correlating portion correlates a word not selected as the infrequently-appearing word by the infrequently-appearing word selecting portion with related data related to the document data.

9. The data managing apparatus of claim 1, wherein
the frequency storage portion stores the information of the frequency for each creator of the document data, and wherein
the infrequently-appearing word selecting portion selects the infrequently-appearing word among the words extracted from the document data by the word extracting portion based on information corresponding to a creator of the document data out of the information stored in the frequency storage portion.

10. The data managing apparatus of claim 1, comprising
an input accepting portion that accepts input of a search keyword, and
a related data searching portion that extracts the related data as a search result based on the ground that the search keyword accepted by the input accepting portion is identical or similar to a word correlated with each of the related data.

11. A data managing method comprising a word extracting step of extracting one or a plurality of words from document data and a correlating step of correlating the words extracted at the word extracting step with related data related to the document data, further comprising:
a frequency storage step of storing information about a frequency of each of the words for each word;
an infrequently-appearing word selecting step of selecting an infrequently-appearing word having the frequency of the word lower than a given threshold value predetermined among the words extracted at the word extracting step based on the information stored at the frequency storage step; and
a frequency updating step of updating the information about frequency stored at the frequency storage step in accordance with extraction at the word extracting step or correlation at the correlating step, wherein
at the correlating step, the infrequently-appearing word selected at the infrequently-appearing word selecting step among the words extracted from the document data at the word extracting step is correlated with the related data related to the document data.

12. A non-transitory, computer readable storage medium storing a data managing program for driving a computer to perform a word-extracting step that extracts one or a plurality of words from document data and a correlating step that correlates the words extracted by the word extracting step with related data related to the document data, the data managing program further driving the computer to perform:
a frequency storage step having information about a frequency of each of the words stored thereon for each word;
an infrequently-appearing word selecting step that selects an infrequently-appearing word having the frequency of the word lower than a given threshold value predetermined among the words extracted by the word extracting step based on the information stored in the frequency storage step; and
a frequency updating step that updates the information about frequency stored in the frequency storage step in accordance with extraction by the word extracting step or correlation by the correlating step,
the correlating step correlating the infrequently-appearing word selected by the infrequently-appearing word selecting step among the words extracted from the document data by the word extracting step with the related data related to the document data.

13. The data managing apparatus of claim 2, wherein the word extracting portion extracts proper nouns and certain common nouns from the document data.

14. The data managing apparatus of claim 3, wherein the word extracting portion extracts proper nouns and certain common nouns from the document data.

15. The data managing apparatus of claim 4, wherein the word extracting portion extracts proper nouns and certain common nouns from the document data.

16. The data managing apparatus of claim 5, wherein the word extracting portion extracts proper nouns and certain common nouns from the document data.
